(19) United States
(12) Patent Application Publication
(10) Pub. No.: US 2007/0283901 A1
(43) Pub. Date: Dec. 13, 2007

(54) Quiet dog collar

(76) Inventor: Morgan Parmenter LeVally, Mantua, NJ (US)

Correspondence Address: DUANE MORRIS, LLP;IP DEPARTMENT, 30 SOUTH 17TH STREET, PHILADELPHIA, PA, 19103-4196, US

(21) Appl. No.: 11/449,477

(22) Filed: Jun. 8, 2006

(51) Int. Cl. A01K 27/00

(52) U.S. Cl. 119/858

(57) ABSTRACT

The presently claimed invention recites an apparatus and method for housing pet identification tags via a modified pet collar. The present invention comprises an identification tag holder that has a belt member with a means for mounting the belt member about a portion of an animal. The belt member also has a billfold-like compartment with a transparent window disposed about a front side of the billfold-like compartment, and an aperture disposed about a length of the billfold-like compartment. The aperture has a length and width large enough to accommodate at least one identification tag, and the aperture provides access to the interior of the billfold-like compartment, with the interior of the billfold-like compartment adapted to receive at least one identification tag so that the identification tag is visible through the transparent window disposed about the front side of the billfold-like compartment. In addition, the invention contemplates a means for connecting the billfold-like compartment to the belt member in such a manner wherein the billfold-like compartment rests substantially flush with the belt member.

### FIELD OF THE INVENTION

The present invention generally relates to the field of animal restraint and more particularly to an apparatus and method for housing pet identification tags via a modified pet collar.

### BACKGROUND OF THE INVENTION

With the ever increasing number of U.S. households either buying or adopting domesticated pets, the pet service industry has become one of the fastest growing American business sectors. Pet owners expend time, effort, and funds on products and services that cater to the needs of their various household pets. In caring for his or her pets, a typical pet owner will expend money on pet food, medical checkups, and on other necessary items that increase the quality of a pet's life. One such necessary pet accoutrement is the pet collar. Pet collars are usually comprised of an appropriately sized strap that fastens around an animal's neck via a buckle or other coupling means. A pet collar is advantageous because it enables a pet owner to attach various necessary accessories to the pet collar without causing any harm or discomfort to the animal. For example, leashes and other tethering apparatus are commonly attached to pet collars, allowing the pet owner to restrict his or her animal to a particular area or to control and guide an animal's movement. Pet collars also provide a means for pet owners to attach identification tags to the animal, so that such vital information as an animal's given name, an animal's address, and an animal's immunization records can be recorded and referenced with ease.

Pet owners are often quite concerned about their animal's safety and well-being. Using an identification tag in conjunction with a pet collar is an important tool in a owner's efforts to preserve their pet's security and safety. Each year there are a large number of family pets that become lost or stranded, and identification tags help reunite lost pets with their original owners. Without an identification tag and the vital information transcribed therein, it would be very difficult to return lost or stranded pets to their owners. Without an identification tag, lost pets are likely to be impounded in a kennel, sent to an animal shelter, and in a worse case scenario, destroyed.

The pet collar provides a practical means to attach an identification tag can to the animal. A pet owner can not physically attach an animal identification tag to the body of the animal itself without causing the animal great pain or discomfort. Because it is unlikely a properly attached pet collar will become unattached from an animal's neck, it is advantageous to secure the animal's identification tag directly to the pet collar. In this way, both the pet collar and the identification tag remain with the pet at all times, ensuring the animal's vital contact and immunization information can easily be discerned by any individual who encounters the lost or stranded animal.

Typically, animal identification tags can be found in a wide variety of different shapes and sizes, and can be comprised of any material suitable for properly preserving the information transcribed thereon. For example, some identification tags are comprised of metal, with the animal's contact information etched or stamped on the face of the metal tag. Still other identification tags are comprised of plastic, with the contact information pre-fabricated and disposed on the face of the identification tag. Still other identification tags are sold “blank,” with no information disposed about the face of the tag, requiring the owner to transcribe the information. Regardless of the material used to comprise the identification tag, the shape of the identification tag, or the method of transcribing the pet's information on the identification tag, most identification tags are attached to the pet collar via one or more hangers.

Usually, one or more ends and/or sides of the pet identification tag are equipped with a loop or fitted with an aperture. A pet owner often will attach one end of a hanger through the pet identification tag loop and/or aperture and attach the other end of the hanger to the pet collar, which also usually has a loop and/or aperture adapted to receive one end of a hanger. A pet identification tag attached to a pet collar in this manner results in a pet identification tag that hangs freely from the face of the pet collar. The face or back of the identification tag is not completely attached or affixed to the pet collar, nor is the identification tag flush with the face of the pet collar. Although attaching a identification tag to a pet collar via a hanger assembly effectively ensures the identification tag will remain affixed to the pet collar, the method is not without its drawbacks and limitations.

For example, pet identification tags that dangle from a pet collar may become unwittingly entangled with any number of potentially hazardous items. A hanging pet identification tag can become tangled with various household articles such as chairs, couches, wire fencing, table legs, or any other household item. Likewise, a hanging pet identification tag can become caught up in various naturally occurring hazards, such as shrubbery, brush, trees, or any other naturally occurring outdoor manifestation. If an animal becomes entangled with any type of object via the hanging identification tag, there is an increased likelihood the animal will be injured, harmed, or have its air supply constricted. Hanging identification tags, therefore, present a potential danger to an animal wearing such tags.

In addition, an identification tag is limited in the amount of information it can hold due to physical space constraints. Pet owners often find it necessary to utilize multiple identification tags. A pet owner may attach one identification tag to his or her pet's collar that contains contact information, and yet another identification tag that contains immunization data. By utilizing multiple hanging identification tags, not only is there an increased risk and likelihood of the animal becoming unwittingly entangled with another object, but multiple hanging identification tags will invariably come in contact with one another. Depending on the material comprising the identification tags, this contact between identification tags may cause an unwanted “clanging” noise every time the animal moves. The noise emanating from one identification tag coming in contact with another identification tag is undesirable and annoying to the animal's owner.

Furthermore, the friction between hanging identification tags rubbing up against other hanging identification tags invariably causes wear on the identification tag itself. Valuable information transcribed on the identification tag can be rubbed off, dulled, corrupted, or rendered unreadable, thereby defeating the purpose of the identification tags. In addition, the friction from the hanging tags may also cause wear on the metallic hanger, increasing the likelihood of the identification tag falling from the hanger and the pet collar. Given these deficiencies, there has been a long felt need for a pet collar that allows an owner to attach an identification tag to the collar in a manner that preserves the integrity of the information, yet does not cause unnecessary noise, or endanger the animal.

The prior art includes a number of pet collars with identification tag features, but no prior art collar satisfactorily discloses or solves the problem of a pet owner's need to use custom identification tags comprised of a metallic or plastic material that can be attached to a collar in such a way that prevents multiple tags from making contact with one another and that eliminates the possibility of the animal becoming entangled with a another object via the identification tags.

For example, U.S. Pat. No. 6,305,329 to Levy, Jr. is directed to a combination of a collar and identification tag device wherein the identification tag device is a wrapper, a hanger, or an attached tag. Each embodiment of the identification tag device is directed to a tag made of sheet material with an adhesive backing placed under a clear overlay, eg., a label under clear plastic, but none of the embodiments disclosed by Levy discloses the use of custom identification tags made of metal or plastic. Further, the hanging and attached identification tag device embodiments disclosed in Levy are not attached to the collar in such a way to prevent multiple identification tags from making contact with each other. Levy fails to address the problem of identification tags clanking together and the problem of friction from hanging identification tags wearing down the information transcribed on the tags.

Another prior art effort is disclosed in U.S. Pat. No. 4,178,879 to Cunningham. The Cunningham patent describes indicia-bearing tabs (e.g., labels) that adhere to a flexible plastic strip that can subsequently be inserted into a clear plastic pouch on a collar. The Cunningham invention does not disclose the use of custom pre-existing identification tags made of such materials as metal or plastic. To use the invention disclosed by Cunningham, a pet owner would need to create his or her own tags, and would not be able to utilize pre-existing identification tags. The Cunningham patent further describes a single transparent pouch on its collar running along a substantial portion of said collar and does not account for the use of multiple tags or contemplate the use of a plurality of pouches for storing multiple identification tags. Furthermore, the transparent pouch disclosed by Cunningham is incapable of accommodating pet identification tags that are rigid or inflexible even thought the large majority of identification tags currently populating the marketplace are of a rigid and inflexible nature. The Cunningham pouch is instead limited to those pet identification tags that are completely flexible and malleable.

In addition to the prior art efforts described above, there are a few prior art methods that employ alternative identification means in lieu of using identification tags. For example, U.S. Pat. No. 3,800,450 to Laugherty et al. and U.S. Pat. No. 4,091,766 to Colliard both use “identification cards” that can be inserted in a pet collar fitted with a tubular configuration. Neither of the embodiments disclosed in Laugherty or Colliard discloses a means of storing standard animal identification tags currently found in the marketplace, i.e. plastic or metallic tags. Additionally, U.S. Pat. No. 5,955,953 to Hanson et al. includes a liquid crystal display, as well as a means for conveying audible information for identifying a pet. Although the embodiment disclosed in Hanson is a self contained unit, it does not allow a pet owner to use pre-existing pet identification tags, and requires a user to manually enter the information via an electronic input means. The information displayed on the liquid crystal display disclosed by Hanson will only last as long as the power source remains active, which means vital contact or immunization information could become lost or corrupted and not serve its stated purpose should the power supply dwindle or actions by the animal render the power supply inoperable.

In reviewing the breadth of available pertinent art, it is clear there is a need for an apparatus and method for housing pet identification tags that adequately preserves the information transcribed on multiple tags, while at the same time minimizing any injury risks to the pet. The presently claimed invention addresses each of these needs.

### SUMMARY OF THE INVENTION

In view of the foregoing disadvantages inherent in the prior art, the present invention provides an improved method and apparatus for housing pet identification tags via a modified pet collar. The present invention essentially comprises an identification tag holder that has a belt member with a means for mounting the belt member about a portion of an animal. The belt member also has a billfold-like compartment with a transparent window disposed about a front side of the billfold-like compartment, and an aperture disposed about a length of the billfold-like compartment. The aperture has a length and width large enough to accommodate at least one identification tag, and the aperture provides access to the interior of the billfold-like compartment, with the interior of the billfold-like compartment adapted to receive at least one identification tag so that the identification tag is visible through the transparent window disposed about the front side of the billfold-like compartment. In addition, the invention contemplates a means for connecting the billfold-like compartment to the belt member in such a manner wherein the billfold-like compartment rests substantially flush with the belt member.

The biggest advantage of the presently claimed invention is that it allows a user to store at least one identification tag in the billfold-like compartment in such a manner that the identification tag does not hang from the collar. The billfold-like compartment keeps an identification tag substantially flush with the belt member, thereby erasing the possibility a hanging identification tag would become entangled with foreign objects and providing better protection for an animal. Moreover, because the billfold-like compartment is fitted with a transparent window, the information transcribed on individual identification tags can still be viewed, even when the identification tag is securely placed in the billfold-like compartment.

In addition to the presently claimed invention comprising a device for housing pet identification tags via a modified pet collar, the presently claimed invention also discloses a method of housing pet identification tags via a modified pet collar, comprising the steps of providing a belt having an attachment at one end for securing the belt in a closed loop about a selected animal, disposing a transparent window about one side of the belt, lying the transparent window substantially flush against one side of the belt and extending a given length of the belt to form an elongated pouch. The transparent window is also fitted with a slot that runs transversely across the transparent window at one end to provide entry into the pouch. The method also envisions the insertion of an identification tag with information transcribed thereon into the elongated pouch through the slot running transversely across the transparent window at one end so that the identification tag is placed in a manner that the information is visible through the transparent window.

The method described above is advantageous, because it allows a user to place at least one identification tag in the pouch which is substantially flush with the belt. Because the pouch is substantially flush with the belt, the inserted identification tag is also substantially flush with the belt, which eradicates the prior art problem of hanging identification tags. The method employed above provides an enhanced means of protecting an animal, while still permitting the information transcribed on the identification tags to be visible through the transparent window.

### BRIEF DESCRIPTION OF THE DRAWINGS

These and other features and advantages of the present invention will be more fully disclosed in, or rendered obvious by, the following detailed description of the preferred embodiment of the invention, which is to be considered together with the accompanying drawings wherein like numbers refer to like parts and further wherein:

FIG. 1 is a front perspective view of an embodiment of the identification tag holder according to the teachings of the presently claimed invention, also showing an identification tag in top plane view;

FIG. 2 is a back perspective view of the identification tag holder according to the teachings of the presently claimed invention;

FIG. 3 is a back perspective view of an alternate embodiment of the identification tag holder according to the teachings of the presently claimed invention;

FIG. 4 is a side perspective view of an embodiment of the presently claimed invention used in conjunction with a collar; and

FIG. 5 is an top perspective view of an embodiment of the invention used in conjunction with a collar.

### DETAILED DESCRIPTION OF THE PREFERRED EMBODIMENT

This description of preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In the description, relative terms such as “horizontal,” “vertical,” “up,” “down,” “top”and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. In the claims, means-plus-function clauses, if used, are intended to cover the structures described, suggested, or rendered obvious by the written description or drawings for performing the recited function, including not only structural equivalents but also equivalent structures.

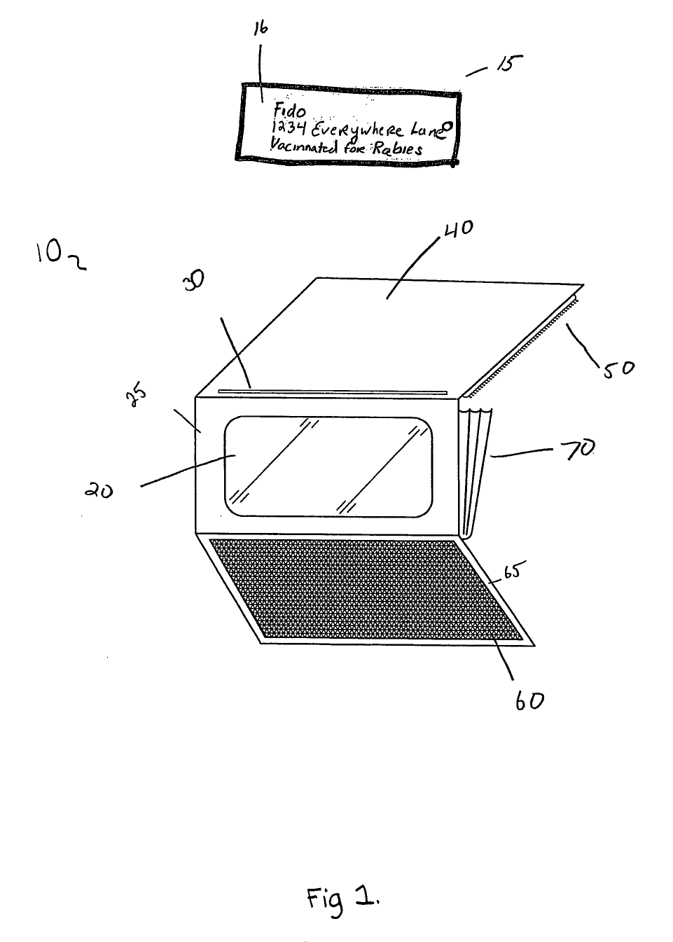

FIG. 1 is a front perspective view of identification tag holder 10. Identification tag holder 10 can be used to hold any number of identification tags 15 or any other appropriately sized three dimensional substrate. Identification tag 15 usually has information disposed about the front side 16 of the identification tag 15. In the particular embodiment depicted in FIG. 1, information is disposed on the front side 16 of identification tag 15, but information can also be displayed on the back side 16a of identification tag 15, or on both the front side 16 and the back side 16a of identification tag 15. In the particular embodiment depicted in FIG. 1, identification tag 15 has a rectangular shape, but identification tag 15 can include any number of possible configurations and shapes. Identification tag 15 can take the shape of any given polygon or design advantageous for disposing information about the front side 16 and/or the back side 16a of identification tag 15. Polymeric materials useful for all or some components of identification tag 15 include, without limitation, plastics, thermoplastics (crystalline or non-crystalline, cross-linked or non-cross linked), thermosetting resins, elastomers, or composites thereof. Identification tag 15 can also be comprised of non-conductive metals, metal alloys, ceramics, wood, wood-plastic composites, plastic-glass fiber reinforced composites, or any other material suitable for displaying information about the front side 16 and/or the back side 16a of identification tag 15. Identification tag 15 can take any number of possible commercial and private forms, including without limitation: an animal identification tag or tags containing an animal's name, address, and immunization information; a military dog tag or tags containing a soldier's name, address, and rank; a health information tag or tags, containing vital health statistics and allergy information; or any other type of identification tag typically found in the art.

In the embodiment depicted in FIG. 1, identification tag 15 fits through aperture 30 and into billfold-like compartment 70, which supports and holds at least one identification tag 15, if not multiple identification tags 15. Identification tag holder 10 has a front face 25 with transparent window 20 disposed about front face 25. Transparent window 25 can be comprised of any suitable material that enables a user to view an object located behind transparent window 25 as if there were no intervening material between the user and the object located behind transparent window 25.

Referring still to FIG. 1, billfold-like compartment 70 is connected to front face 25 in such a way that there is not a gap between billfold-like compartment 70 and front face 25. This ensures that any identification tags 15 placed into billfold-like compartment 70 via aperture 30 will remain in billfold-like compartment 70 and not fall out of billfold-like compartment 70. Moreover, because the front face 25 of identification tag holder 10 is disposed with transparent window 20, any identification tag 15 placed in billfold-like compartment 70 through aperture 30 can be viewed through transparent window 20. By placing identification tag 15 in billfold-like compartment 70, the information transcribed on identification tag 15 can be viewed through transparent window 20, so long as the side of the identification tag 15 with the information transcribed therein is facing transparent window 20. In this way, it is possible for anyone to view the information transcribed on identification tag 15 through transparent window 20.

By placing identification tag 15 through aperture 30 and into billfold-like compartment 70, an individual utilizing the presently claimed invention can store identification tag 15 by means of billfold-like compartment 70, and at the same time can view the information transcribed on identification tag 15 through transparent window 20. The presently claimed invention provides a means of holding identification tags 15 without the need of hanging identification tags 15 from a collar. This is advantageous because any number of identification tags 15 can be placed in billfold-like compartment 70, solving the prior art problem of hanging identification tags 15 rubbing up against each other and damaging the transcribed information, the prior art problem of the unwanted “clanging” noise that occurs when multiple hanging identification tags 15 bang up against each other, and the prior art problem of hanging identification tags 15 becoming entangled with other objects.

When considering the means by which identification tag holder 10 can be attached to a collar, the presently claimed invention contemplates a plethora of possibilities. For example, identification tag holder 10 can either be permanently connected to a collar or be temporarily connected to a collar and removable. If identification tag holder 10 is permanently connected to a collar, any number of means known in the art can be utilized to permanently connect the identification tag holder 10 to a collar. For example, identification tag holder 10 can be stitched to the collar using thread, or identification tag holder 10 can be connected with a collar using any number of appropriate adhesives prevalent in the art.

In those instances where identification tag holder 10 is temporarily connected to a collar and is removable, there are any number of contemplated means for connecting identification tag holder 10 to a collar. In the particular embodiment depicted in FIG. 1, applicant discloses the use of Velcro® hook-and loop-fasteners. Velcro® is a brand name of fabric hook-and-loop fasteners used for connecting objects. Velcro® fastener applications typically consist of two layers, a “hook” side, which is a piece of fabric covered with tiny plastic hooks, and a “loop” side, which is covered with even smaller and shaggier plastic loops. There are many variations to this embodiment, including, without limitation, hooks on both sides, for example. Regardless of the exact type of Velcro® utilized, when the two sides are pressed together, the hooks catch in the loops and hold the pieces together.

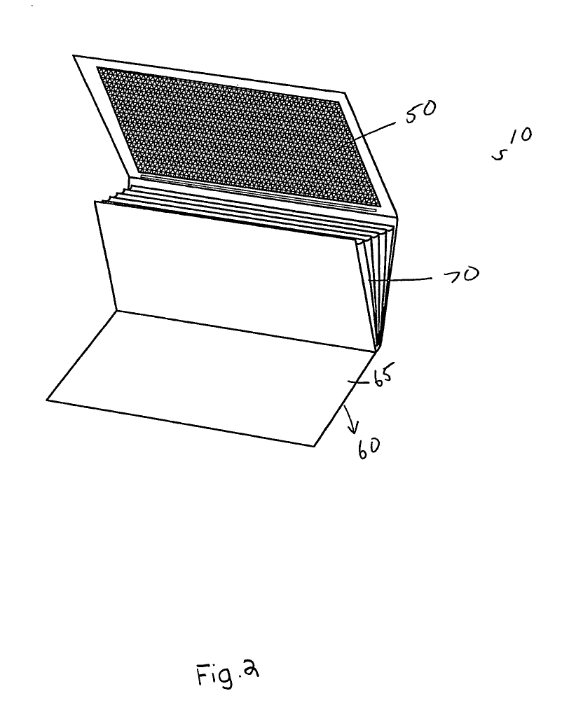

Referring to FIG. 1, hooks 50 are disposed on the top panel 40 of identification tag holder 10 and loops 60 are disposed on the bottom panel 65 of identification tag holder 10. When placing a collar adjacent to billfold-like compartment 70, top panel 40 and bottom panel 60 fold up and around the collar, the connection then being secured via hooks 50 catching in loops 60 and holding top panel 40 together with bottom panel 65. Referring to FIG. 2, depicted is a back perspective view of an identification tag holder 10. FIG. 2 provides a back perspective view of hook 50, billfold-like compartment 70, and bottom panel 65. In addition to the use of Velcro®, the presently claimed invention envisions any number of possible means for fastening identification tag holder 10 about a collar. Some non limiting examples of possible means for connecting identification tag holder 10 about a collar, include: buttons, string, elastic, prefabricated molding, fasteners, and any other fastening means contemplated and known in the art.

In addition, the presently claimed invention envisions the use of identification tag holder 10 without attaching it to a collar. Identification tag holder 10 can wrap around an animal's appendage, such as an arm or leg. For example, instead of attaching identification tag holder 10 to the collar of a pet, the identification tag holder 10 can be wrapped around an animal's leg. For human use, the identification tag holder 10 can be wrapped around a wrist or an ankle. The identification tag holder 10 can be wrapped around any appropriate body part, so long as the hooks 50 are able to catch loops 60.

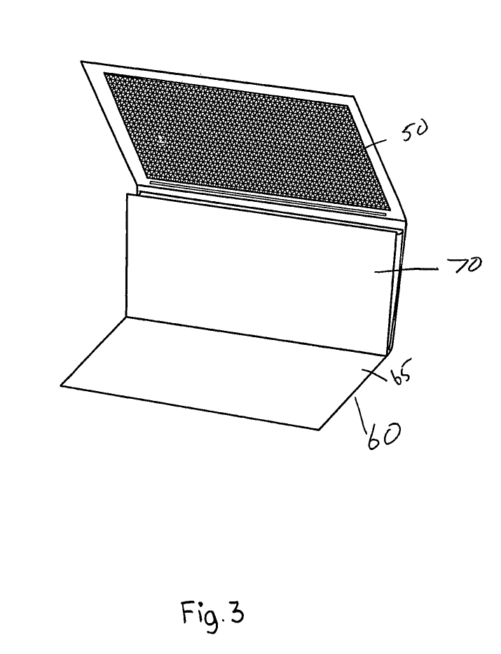

The presently claimed invention envisions any number of pockets for billfold-like compartment 70, to accommodate any number of identification tags 15. Notice that the billfold-like compartment 70 of FIG. 2, is equipped with multiple pockets, whereas the billfold-like compartment 70 of FIG. 3, is equipped with a single pocket. The configuration of billfold-like compartment 70 can take any number of possible forms to accommodate any number of different types of identification tags. Regardless of the configuration of a given billfold-like-compartment, it is characterized by the ability to form a pouch into which items can securely be stored. The billfold-like compartment 70 can also be comprised of any type of material that appropriate to properly store any inserted identification tags 15, including without limitation: canvas, plastic, fabric, waterproofing agents, or any other type of material typically used in the art.

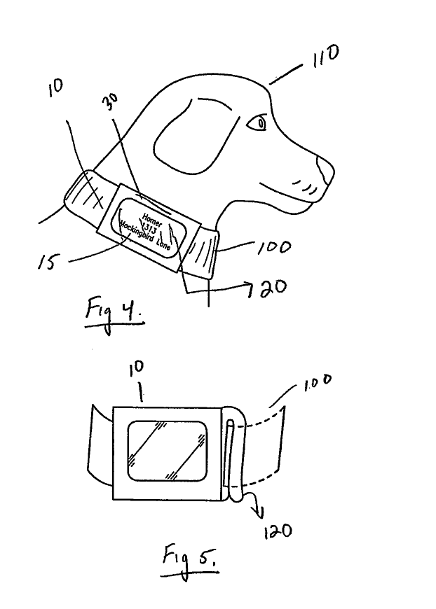

Referring now to FIG. 4, depicted is a non-limiting example of the invention as presently contemplated. In FIG. 4. the identification tag holder 10 is disposed about collar 100. Identification tag 15 is positioned through aperture 30 and the information transcribed about Identification tag 15 is visible through transparent window 20. Referring to FIG. 5, depicted is a non-limiting example of identification tag 15 disposed about collar 100. In this example, identification tag holder 10 is attached to collar 100 via clip 120. Clip 120 is equipped with an aperture with a width at least wide enough to meet or exceed the width of any given collar 100, allowing collar 100 to fit through Clip 120. Clip 120 allows a user to remove and manipulate identification tag holder 10 without physically removing the collar 100. This is advantageous, in that a user can add or remove numerous identification tags 15 as needed and easily review the contents therein.

It is to be understood that the present invention is by no means limited only to the particular constructions herein disclosed and shown in the drawings, but also comprises any modifications or equivalents within the scope of the claims.

We claim:

1. An identification tag holder comprising:
a belt member having a means for mounting the belt member about a portion of an animal; and
a billfold-like compartment with a transparent window disposed about a front side of the billfold-like compartment, the billfold-like compartment further comprising:
an aperture disposed about a length of said billfold-like compartment, the aperture having a length and width large enough to accommodate at least one identification tag, the aperture further providing access to the interior of the billfold-like compartment, the interior of the billfold-like compartment adapted to receive at least one identification tag so that the identification tag is visible through the transparent window disposed about the front side of the billfold-like compartment; and
a means for connecting the billfold-like compartment to the belt member wherein the billfold-like compartment rests substantially flush with the belt member.

2. The identification tag holder of claim 1, wherein the belt member is comprised of an animal collar, and the means for mounting the animal collar about a portion of the animal is comprised of a buckle.

3. The identification tag holder of claim 1, wherein the means for connecting the billfold-like compartment to the belt member are comprised of connecting numerous hooks disposed about a first panel of the billfold-like compartment with numerous loops disposed about a second panel of the billfold-like compartment.

4. The identification tag holder of claim 1, wherein the billfold-like compartment is permanently affixed to the belt member.

5. The identification tag holder of claim 1, wherein the billfold-like compartment is detachably affixed to the belt member.

6. The identification tag holder of claim 1, wherein the aperture is formed by a transverse opening across a top length of the billfold-like compartment.

7. The identification tag holder of claim 1, wherein the aperture is formed by a transverse opening across a bottom length of the billfold-like compartment.

8. The identification tag holder of claim 1, wherein the aperture is formed by a transverse opening across a side of the billfold-like compartment.

9. The identification tag holder of claim 1, wherein the transparent window is comprised of an integral clear plastic strip.

10. The identification tag holder of claim 1, wherein the animal is a human being.

11. The identification tag holder of claim 1, wherein the animal is a canine.

12. The identification tag holder of claim 1, wherein the animal is a feline.

13. The identification tag holder of claim 1, wherein the animal is a equine.

14. A kit for assembling an identification tag holder for animals comprising:
a belt member having a means for mounting the belt member about a portion of an animal; and
a billfold-like compartment with a transparent window disposed about a front side of the billfold-like compartment, the billfold-like compartment further comprising:
an aperture disposed about a length of said billfold-like compartment, the aperture having a length and width large enough to accommodate at least one identification tag, the aperture further providing access to the interior of the billfold-like compartment, the interior of the billfold-like compartment adapted to receive at least one identification tag so that the identification tag is visible through the transparent window disposed about the front side of the billfold-like compartment; and
a means for connecting the billfold-like compartment to the belt member wherein the billfold-like compartment rests substantially flush with the belt member.

15. The kit for assembling an identification tag holder of claim 14, wherein the belt member is comprised of an animal collar, and the means for mounting the animal collar about a portion of the animal is comprised of a buckle.

16. The kit for assembling an identification tag holder of claim 14, wherein the means for connecting the billfold-like compartment to the belt member are comprised of connecting numerous hooks disposed about a first panel of the billfold-like compartment with numerous loops disposed about a second panel of the billfold-like compartment.

17. The kit for assembling an identification tag holder of claim 14, wherein the billfold-like compartment is permanently affixed to the belt member.

18. The kit for assembling an identification tag holder of claim 14, wherein the billfold-like compartment is detachably affixed to the belt member.

19. The kit for assembling an identification tag holder of claim 14, wherein the aperture is formed by a transverse opening across a top length of the billfold-like compartment.

20. The kit for assembling an identification tag holder of claim 14, wherein the aperture is formed by a transverse opening across a bottom length of the billfold-like compartment.

21. The kit for assembling an identification tag holder of claim 14, wherein the aperture is formed by a transverse opening across a side of the billfold-like compartment.

22. The kit for assembling an identification tag holder of claim 14, wherein the transparent window is comprised of an integral clear plastic strip.

23. The kit for assembling an identification tag holder of claim 14, wherein the animal is a human.

24. The kit for assembling an identification tag holder of claim 14, wherein the animal is a canine.

25. The kit for assembling an identification tag holder of claim 14, wherein the animal is a feline.

26. The kit for assembling an identification tag holder of claim 14, wherein the animal is a equine.

27. A method of storing identification tags on an animal collar comprising the steps:
providing a belt having an attachment at one end for securing the belt in a closed loop about a selected animal;
disposing a transparent window lying substantially flush against one side of the belt and extending a given length of the belt to form an elongated pouch, the transparent window having a slot running transversely across the transparent window at one end to provide entry into the pouch; and
inserting an identification tag with information transcribed thereon into the elongated pouch through the slot running transversely across the transparent window at one end, the identification tag placed in a manner that the information is visible through the transparent window.

28. The method of claim 27, wherein the slot is formed by a transverse opening across a top end of the transparent window.

29. The method of claim 27, wherein the slot is formed by a transverse opening across a bottom end of the transparent window.

30. The method of claim 27, wherein the slot is formed by a transverse opening across a side of the transparent window.

31. The method of claim 27, wherein the transparent window is comprised of an integral clear plastic strip.

32. The method of claim 27, wherein the animal is a human.

33. The method of claim 27, wherein the animal is a canine.

34. The method of claim 27, wherein the animal is a feline.

35. The method of claim 27, wherein the animal is a equine.
